(19) United States
(12) Patent Application Publication
(10) Pub. No.: US 2026/0204846 A1
(43) Pub. Date: Jul. 16, 2026

(54) PLUG CONNECTOR AND RECEPTACLE CONNECTOR

(71) Applicant: LS MTRON LTD., Anyang-si, Gyeonggi-do (KR)

(72) Inventors: Su Chan LEE, Anyang-si, Gyeonggi-do (KR); In Duk SONG, Anyang-si, Gyeonggi-do (KR); Kyung Hae CHOI, Anyang-si, Gyeonggi-do (KR)

(21) Appl. No.: 19/137,390

(22) PCT Filed: Jan. 29, 2024
(86) PCT No.: PCT/KR2024/001360

§ 371 Date: Jun. 10, 2025

(30) Foreign Application Priority Data
Jan. 30, 2023 (KR) 10-2023-0011675
Jan. 23, 2024 (KR) 10-2024-0010143

(51) Int. Cl. H01R 13/6594; H01R 12/71

(52) U.S. Cl. CPC H01R 13/6594; H01R 12/716

(57) ABSTRACT

Disclosed are a plug connector and a receptacle connector. A plug connector according to one aspect of the present disclosure may comprise a plug insulator, a plug shield member, and a plug contact. A receptacle connector according to another aspect of the present disclosure may comprise a receptacle insulator, a receptacle shield member, and a receptacle contact.

### CROSS-REFERENCE TO RELATED APPLICATIONS

This application is a National Stage of International Application No. PCT/KR2024/001360, filed Jan. 29, 2024, which claims priority to and the benefit of Korean Patent Application No. 10-2023-0011675, filed Jan. 30, 2023, and Korean Patent Application No. 10-2024-0010143, filed Jan. 23, 2024, the disclosures of which are incorporated herein by reference in its entirety.

### FIELD

The present disclosure relates to a plug connector and a receptacle connector, and more particularly, to a plug connector and a receptacle connector capable of being miniaturized, while improving contact reliability, and having a shielding function.

### BACKGROUND

In general, a mobile terminal such as a mobile phone and a smartphone are equipped with various electrical and electronic components, including various printed circuit boards (PCB), and has a configuration in which these electrical and electronic components are electrically connected without affecting each other, which is considered very important for miniaturization and thinning.

A connector is a configuration installed in an electronic device such as a mobile phone, a computer, or a tablet computer, and electrically connects various components installed in the electronic device to each other, and is provided in the mobile terminal described above, and is used for connecting printed circuit boards (PCB) or electronic components in which a conductive wire is patterned.

Typically, as a connector for a substrate, that is, a board to board (B2B) connector includes a plug connector and a receptacle connector, each of which is connected to different module substrates.

In addition, the plug connector and the receptacle connector are coupled with each other as counterpart connectors to make contact therebetween, thereby enabling the transmission of signals through the different substrates.

Meanwhile, the mobile terminal is configured to achieve increasingly high-function performance in a limited space. In particular, as the camera function becomes increasingly high-magnification, the number of cameras is also increasing.

However, since the camera function having high-performance needs to be implemented in the limited space, the size of the module substrate implementing the camera function is pursued to be as small as possible. Accordingly, the plug connector and the receptacle connectors constituting the B2B connector need to be miniaturized (size-reducing) while also having multiple contacts.

In particular, it is necessary to be able to effectively transmit signals without any noise while not affecting modules for implementing other functions in a narrow space of the mobile terminal. That is, it is necessary to transmit the electric signals without noise or loss as well as a demand for high-density mounting of the connector along with miniaturization or high-function of the mobile terminal.

However, the connector provided in the conventional mobile terminal has a structure including contacts arranged in two rows, and thus has difficulty in miniaturization, and also has a problem in that signal interference and noise are high due to proximity arrangement with other modules in the limited space.

Accordingly, there is an urgent need for the development of the plug connector and the receptacle connector that are miniaturized while improving contact reliability and having a shielding function to block signal interference and noise.

### SUMMARY

The present disclosure is to solve the above problems, and the purpose of the present disclosure is to provide a plug connector and a receptacle connector that are miniaturized while increasing contact reliability, reducing signal interference from other modules on a substrate, and having a shielding function to block noise.

In addition, the purpose of the present disclosure provides a plug connector and a receptacle connector including a shield continuously formed without a break so as to completely shield the circumference of the connector.

In addition, the purpose of the present disclosure provides a plug connector and a receptacle connector having a structure in which contacts are arranged in one row and having a small size and maximizing contact reliability.

In addition, the purpose of the present disclosure provides a plug connector and a receptacle connector having a high reliability by reducing a possibility of damage when the plug connector and the receptacle connector are coupled in a misaligned state.

The present disclosure is not limited to the above-described tasks, and other tasks not mentioned will be clearly understood by those skilled in the art from the following description.

According to an aspect of the present disclosure, a plug connector is provided.

A plug connector 100 coupled with a receptacle connector 200, which comprises a plug insulator 110, including a plug bottom plate 111 configured to have a length in a first direction and a width in a second direction, a plug sidewall 112 configured to extend along a circumference of the plug bottom plate 111 and have a height in a third direction to define a receiving space S in which the receptacle connector 200 is received, and an island 113 configured to have a length in the first direction and protrude in the third direction on the plug bottom plate 111; a plug shield 120 configured to be coupled with the plug insulator 110 by wrapping around a circumference thereof and mounted on a substrate; and a plurality of plug contacts 130 configured to be arranged in one row having a pitch of an arrangement gap d1 on the island 113 in the first direction, plug mount sections 134 thereof mounted on the substrate each having a mounter gap d2 and being arranged on both sides of the island 113 in the second direction in a zigzag manner, and being exposed from a bottom surface of the plug bottom plate 111,
wherein the plug shield 120 including a first shielding portion 121 configured to wrap around an outer circumference of the plug insulator 110, an upper coupling portion 122 configured to cover an upper surface of the plug sidewall 112 and continuous without a break, and a second shielding portion 123 configured to wrap around an inner circumference of the plug insulator 110,
wherein the second shielding portion 123 includes a fixing piece 123a configured to be bent downward from the upper coupling portion 122 in the third direction, and a movable piece 123b configured to be bent downward from the upper coupling portion 122 in the third direction and be arranged to be spaced apart from the fixing piece 123a by a cutoff gap e3 and be elastically deformable according to coupling with the receptacle connector 200.

According to another aspect of the present disclosure, a receptacle connector is provided.

A receptacle connector 200 coupled with the plug connector 100, which comprises a receptacle insulator 210 received in a receiving space S of the plug connector 100, including a receptacle bottom 211 and a receptacle retaining wall 212 configured to extend along a circumference of the receptacle bottom 211 and have a height in a third direction to form a receiving groove S1 in which an island 113 of the plug connector 100 is received; a receptacle shield 220 coupled with while warping around a circumference of the receptacle insulator 210 and mounted on a substrate, including a plurality of first receptacle shields 220a configured to be arranged on a rim of the receptacle insulator 210 in a first direction or a second direction, and a second receptacle shield 220b configured to be arranged on a corner of the receptacle insulator 210 while connecting the first receptacle shields 220a without a break; and a plurality of movable receptacle contacts 230 arranged in one row with a pitch of an arrangement gap d1′ in the first direction on the receptacle bottom 211, receptacle mount sections 235 thereof mounted on the substrate each having a mounter gap d2′ longer than the arrangement gap d1′ and being exposed from the bottom surface of the receptacle bottom 211 while being arranged in a zigzag manner on both sides in the second direction.

According to the above configuration, in the plug connector and the receptacle connector according to the present disclosure, the plurality of plug contacts are arranged in one row along a length in the first direction on the island of the plug insulator and the plug mount section is alternately arranged in a zigzag manner on both sides in the second direction of the island, and has the effect of minimizing the gap between contacts (ultra-narrow pitch) and reducing the width of the entire connector.

In addition, as the plug mount section is alternately arranged in a zigzag manner on both sides in the second direction of the island, gaps between adjacent plug mount sections are increased to prevent interference between PCB patterns on the substrate, thereby reducing the risk of short circuit.

In addition, the receptacle connector has a plurality of receptacle contacts arranged in one row along a length of the first direction on the receptacle bottom of the receptacle insulator so as to correspond to the plug contacts of the plug connector to be coupled, and since the receptacle mount sections are alternately arranged in a zigzag manner on both sides of the second direction of the receptacle bottom, and has the effect of minimizing the gap between contacts (ultra-narrow pitch) and reducing the width of the entire connector.

In addition, since the receptacle mount sections are alternately arranged in a zigzag manner on both sides of the second direction of the receptacle bottom, and gaps between the mount sections are increased to prevent interference between PCB patterns on the substrate, thereby reducing the risk of short circuit.

In addition, a miniaturization of the plug connector and the receptacle connector to be coupled has the effect of allowing transmission of electrical signals without noise or loss without affecting other modules of the electronic device.

In addition, the plug contact and the receptacle contact have a dual contact structure in which a first contact area and a second contact area are alternately formed around the island of the plug connector, which may increase the signal transmission rate and also increase the overall contact reliability by maintaining the contact of any one area even under external force.

In addition, the plug connector includes a plug shield wrapping around a circumference of the plug insulator in a continuous shape without a seam or a break through a drawing method, and the receptacle connector includes a receptacle shield wrapping around a circumference of the receptacle insulator in a continuous shape without a seam or a break through a drawing method, so that the plug contact and the receptacle contact to be coupled may be completely disconnected from the outside, thereby enabling complete shielding.

In addition, when the plug connector and the receptacle connector are coupled with each other, a first shielding portion and a second shielding portion of the plug shield and a receptacle shielding portion of the receptacle shield may form a triple shielding structure, thereby maximizing shielding performance.

In addition, since the plug shield includes an elastically deformable movable piece, the plug shield may be stably coupled with the receptacle shield while reducing an insertion force.

In addition, the plug shield may be prevented from being damaged and may stably guide the coupling even when a first width in a corner diagonal direction is formed to be long to strongly contact the receptacle shield to be coupled.

In addition, the receptacle shield has an embossed contact portion protruding outwardly at a corner portion having a small deformation, thereby improving contact stability and coupling force with the plug shield.

It should be understood that the effects of the present disclosure are not limited to the above-described effects, and include all effects that can be inferred from the construction of the disclosure described in the detailed description or the claims.

### BRIEF DESCRIPTION OF THE DRAWINGS

FIG. 1 is a view illustrating a connector in which a plug connector and a receptacle connector are coupled according to an embodiment of the present disclosure.

FIG. 2 is a view illustrating a state in which the coupled connector of FIG. 1 is viewed from above.

FIG. 3 is a view illustrating a state in which the coupled connector of FIG. 1 is viewed from below.

FIG. 4 is a view illustrating a state in which the plug connector and the receptacle connector are separated according to an embodiment of the present disclosure.

FIG. 5 is a perspective view illustrating a plug connector according to an embodiment of the present disclosure.

FIG. 6 is an exploded perspective view illustrating the plug connector of FIG. 5.

FIG. 7 is a view illustrating a state in which the plug connector is viewed from above.

FIG. 8 is a view illustrating a plug contact applied to the plug connector according to an embodiment of the present disclosure.

FIGS. 9 and 10 are a view illustrating a cross-section of I-I′ of FIG. 7 and an enlarged view of part “A” thereof, respectively.

FIGS. 11 and 12 are a view illustrating a cross-section of II-II′ of FIG. 7 and an enlarged view of part “B” thereof, respectively

FIG. 13 is a perspective view illustrating a receptacle connector according to an embodiment of the present disclosure.

FIG. 14 is an exploded perspective view illustrating the receptacle connector of FIG. 13.

FIG. 15 is a view illustrating a receptacle contact applied to the receptacle connector according to an embodiment of the present disclosure.

FIG. 16(a) and 16(b) are a view illustrating a state in which a receptacle connector is viewed from above and an example of a coupling protrusion provided thereon, respectively.

FIGS. 17 and 18 are views illustrating a cross-section of III-III′ and a cross-section of IV-IV′ of FIG. 16(a), respectively.

FIGS. 19 and 20 are views illustrating a receptacle PCB pattern and a plug PCB pattern in a connected connector of the plug connector and the receptacle connector according to an embodiment of the present disclosure, respectively.

FIGS. 21 to 23 are views illustrating a cross-section of V-V′, a cross-section of VI-VI′ and a cross-section of VII-VII′ in FIG. 19.

FIGS. 24 to 26 are views illustrating a process in which a plug connector and a receptacle connector are coupled according to an embodiment of the present disclosure based on the cross-section of FIG. 21.

### DETAILED DESCRIPTION

The present disclosure, in its best form, proposes a plug connector 100 coupled with a receptacle connector 200.

The plug connector 100 comprises a plug insulator 110, including a plug bottom plate 111 configured to have a length in a first direction and a width in a second direction, a plug sidewall 112 configured to extend along a circumference of the plug bottom plate 111 and have a height in a third direction to define a receiving space S in which the receptacle connector 200 is received, and an island 113 configured to have a length in the first direction and protrude in the third direction on the plug bottom plate 111; a plug shield 120 configured to be coupled with the plug insulator 110 by wrapping around a circumference thereof and mounted on a substrate; and a plurality of plug contacts 130 configured to be arranged in one row having a pitch of an arrangement gap d1 on the island 113 in the first direction, plug mount sections 134 thereof mounted on the substrate each having a mounter gap d2 and being arranged on both sides of the island 113 in the second direction in a zigzag manner, and being exposed from a bottom surface of the plug bottom plate 111,
wherein the plug shield 120 including a first shielding portion 121 configured to wrap around an outer circumference of the plug insulator 110, an upper coupling portion 122 configured to cover an upper surface of the plug sidewall 112 and continuous without a break, and a second shielding portion 123 configured to wrap around an inner circumference of the plug insulator 110,
wherein the second shielding portion 123 includes a fixing piece 123a configured to be bent downward from the upper coupling portion 122 in the third direction, and a movable piece 123b configured to be bent downward from the upper coupling portion 122 in the third direction and be arranged to be spaced apart from the fixing piece 123a by a cutoff gap e3 and be elastically deformable according to coupling with the receptacle connector 200.

The present disclosure proposes, in another best form, a receptacle connector 200 coupled with a plug connector 100.

The receptacle connector 200 comprises a receptacle insulator 210 received in a receiving space S of the plug connector 100, including a receptacle bottom 211 and a receptacle retaining wall 212 configured to extend along a circumference of the receptacle bottom 211 and have a height in a third direction to form a receiving groove S1 in which an island 113 of the plug connector 100 is received; a receptacle shield 220 coupled with while warping around a circumference of the receptacle insulator 210 and mounted on a substrate, including a plurality of first receptacle shields 220a configured to be arranged on a rim of the receptacle insulator 210 in a first direction or a second direction, and a second receptacle shield 220b configured to be arranged on a corner of the receptacle insulator 210 while connecting the first receptacle shields 220a without a break; and a plurality of receptacle contacts 230 arranged in one row with a pitch of an arrangement gap d1′ in the first direction on the receptacle bottom 211, receptacle mount sections 235 thereof mounted on the substrate each having a mounter gap d2′ and being exposed from the bottom surface of the receptacle bottom 211 while being arranged in a zigzag manner on both sides in the second direction,
wherein the first receptacle shield 220a and the second receptacle shield 220b each include the first shielding portion 121 configured to wrap around an outer circumference of the plug insulator 110 without a break while having a height in the third direction, and
wherein the second receptacle shield 220b includes a receptacle corner coupling portion 222 configured such that a third direction upper end of the receptacle shielding portion 221 is continuous without a break while covering the corner of the receptacle retaining wall 212.

Hereinafter, exemplary embodiments of the present disclosure will be described in detail so that those of ordinary skill in the art can readily implement the present disclosure with reference to the accompanying drawings.

In the present disclosure, a component is located in a “front”, a “rear”, an “upper” or a “lower” of another component, unless otherwise specified, not only in the case that the component is located in a “front”, a “rear”, an “upper” or a “lower” immediately adjacent to the other component, but also in the case that another component is arranged in between. In addition, a component is connected to another component, unless otherwise specified, not only in the case that the component is directly connected to the other component, but also in the case that the component is indirectly connected to the other component.

The terms “X-axis”, “Y-axis”, and “Z-axis” used in the description will be understood by referring to the coordinate system shown in the drawings. And, in the description, the X-axis direction is referred to as a first direction, the Y-axis direction is referred to as a second direction, and the Z-axis direction is referred to as a third direction, but this is merely one example according to a relative point of view, and the first to third directions and the coordinate axes (Z, Y, Z-axes) are introduced to illustrate relative positions between the components, and the absolute positions of the components are not limited.

Hereinafter, in the description of the present disclosure, a detailed description of related known functions or configurations will be omitted so as not to obscure the subject matter of the present disclosure.

Meanwhile, the names of the plug connector and the receptacle connector are merely referred to for the purpose of describing the present disclosure, and the names of the plug connector in the illustration may be referred to as the receptacle connector, or the names of the receptacle connector may be referred to as the plug connector.

Hereinafter, a plug connector and a receptacle connector according to an embodiment of the present disclosure will be described with reference to the drawings.

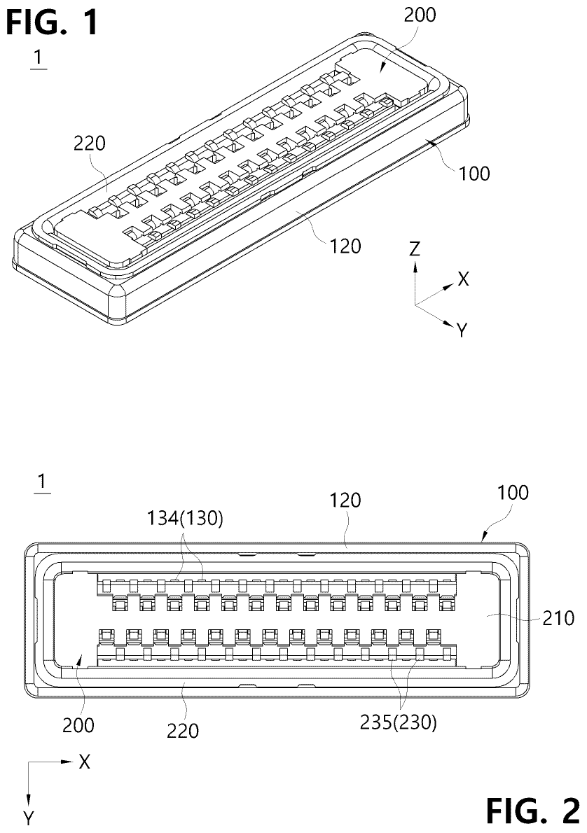

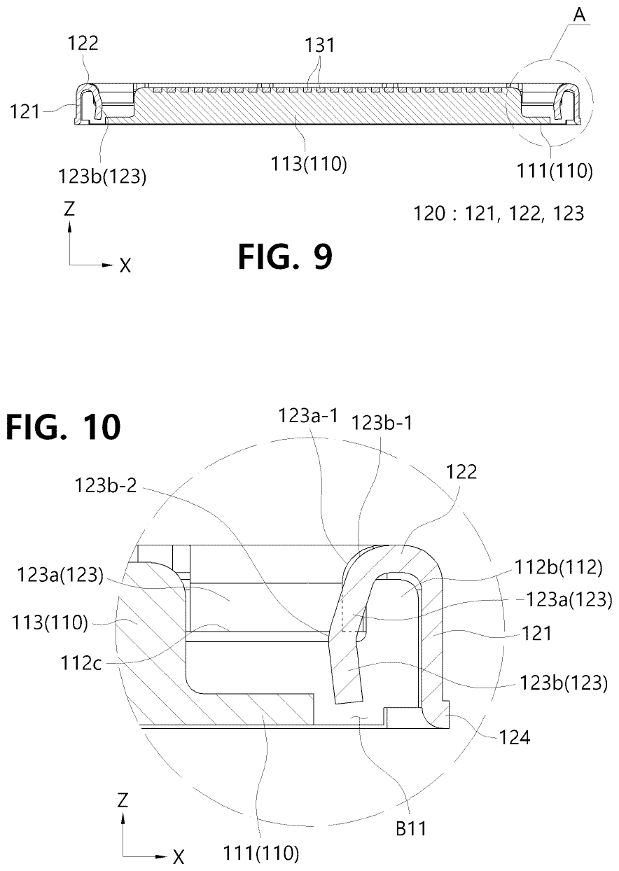

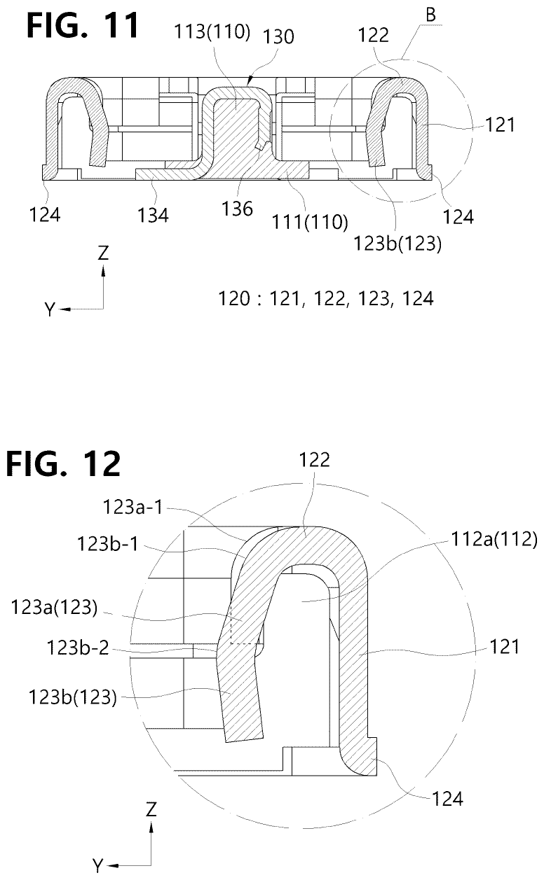

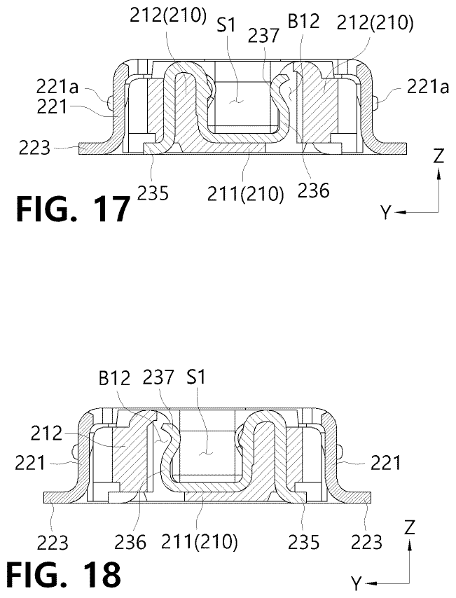

First, referring to FIGS. 1 to 26, a connector 1 according to an embodiment of the present disclosure may be a B2B connector that is physically coupled with each other to electrically connect two different substrates.

That is, the connector 1 according to an embodiment of the present disclosure may include a plug connector 100 and a receptacle connector 200 that are physically coupled with each other as shown.

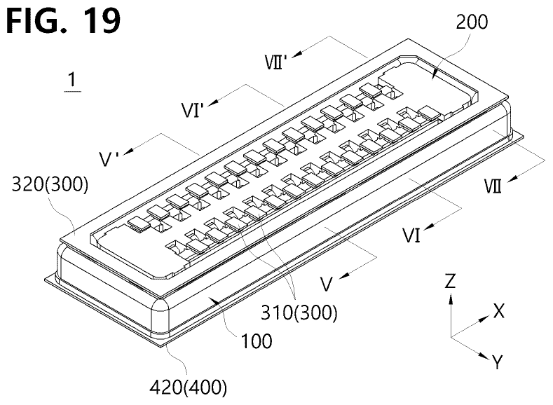

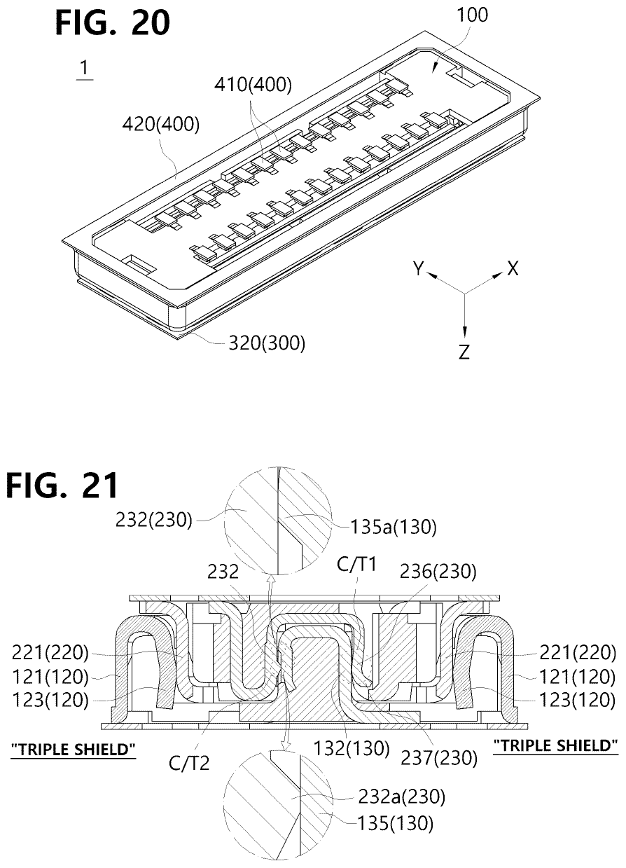

In this case, the plug connector 100 may be mounted on one module substrate (not shown) through a plug PCB pattern 400 (FIG. 20) and the receptacle connector 200 may be mounted on another module substrate (not shown) through a receptacle PCB pattern 300 (FIG. 19).

At this time, the plug shield 120 of the plug connector 100 is continuously formed without a seam or a break, and forms a shield through being mounted on the plug shield pattern 420 (FIG. 20) of the closed loop structure of the plug PCB pattern 400 (FIG. 20) to implement a shielding function.

And, the receptacle shield 220 of the receptacle connector 200 is continuously formed without a seam or a break, and forms a shield through being mounted on the receptacle shield pattern 320 (FIG. 19) of the closed loop structure of the receptacle PCB pattern 300 (FIG. 19) to implement a shielding function.

And, when the plug connector 100 and the receptacle connector 200 are physically coupled with each other, the module substrate on which the plug connector 100 is mounted and the module substrate on which the receptacle connector 200 is mounted may be electrically connected with each other.

Meanwhile, the plug connector 100 and the receptacle connector 200 according to an embodiment of the present disclosure may be miniaturized to facilitate installation of the highly integrated electronic device in a limited space and may have a coupling force to increase contact reliability between each other.

In addition, the plug connector 100 and the receptacle connector 200 are configured to have shields 120 and 220 that completely surround a circumference without the seam or the break through a drawing method to block signal interference and noise, thereby increasing the shielding function.

To this end, the plug connector 100 generally has a receiving space S and includes a plug insulator 110 configured to be provided with a protruding island 113, a plug shield 120 surrounding a circumference of the plug insulator 110, and a plug contact 130 configured to transmit electrical signals.

And, the receptacle connector 200 has a shape that may be received in the above-described receiving space S as a whole, and includes a receptacle insulator 210 configured to have a receiving groove S1 for accommodating the island 113 of the plug connector 100, a receptacle shield 220 configured to surround a circumference of the receptacle insulator 210, and a receptacle contact 230 configured to transmit electrical signals.

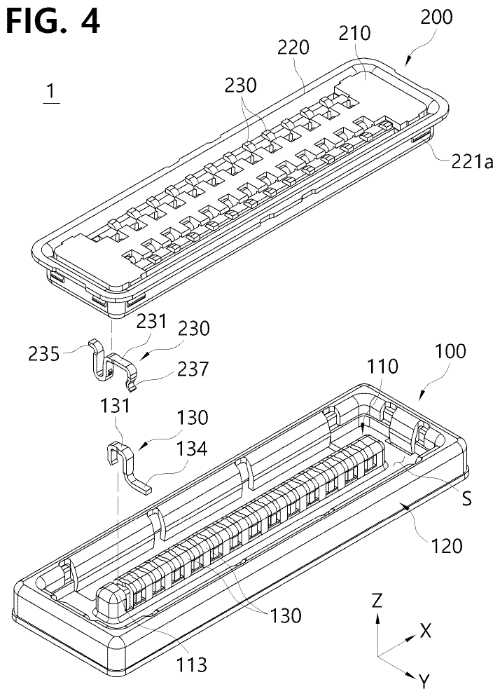

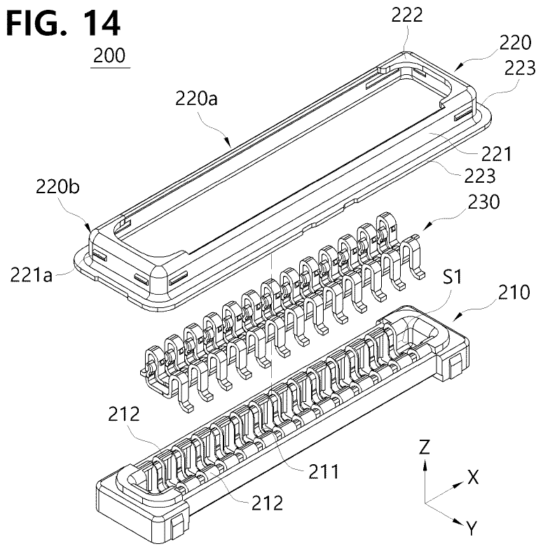

Meanwhile, the receptacle connector 200 is accommodated and coupled in the receiving space S (FIG. 4) of the plug connector 100, and in this case, the island 113 of the plug connector 100 is accommodated in the receiving groove S1 (FIG. 14) of the receptacle connector 200.

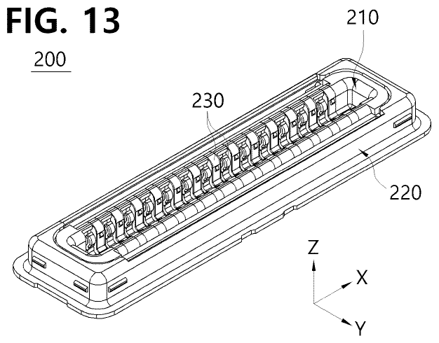

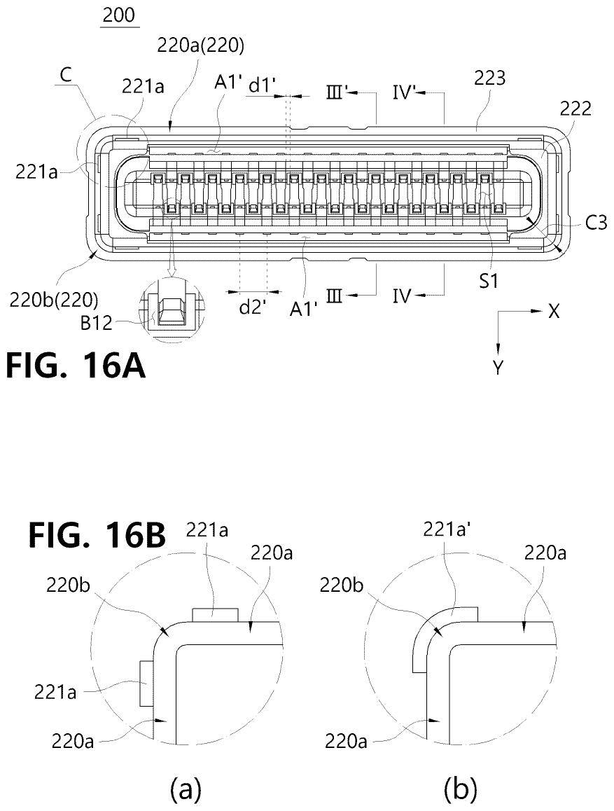

Meanwhile, the plug contact 130 has a structure in which it is arranged in one row along a length in a first direction on the island 113 of the plug insulator 110 (see FIGS. 4 to 6), and the receptacle contact 230 has a structure in which it is arranged in one row along the length in the first direction on the receptacle bottom 211 of the receptacle insulator 210 (see FIGS. 13 and 16A).

Specifically, the plug connector 100 includes a plurality of plug contacts 130 having the same structure.

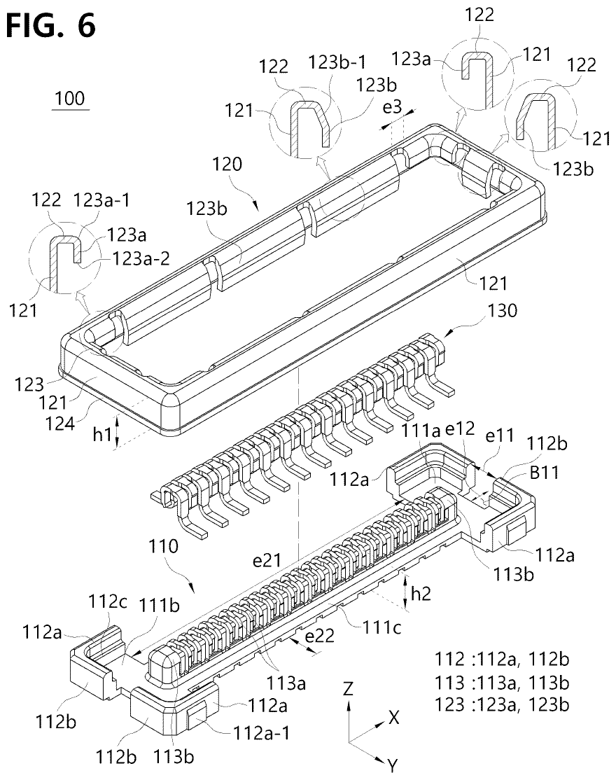

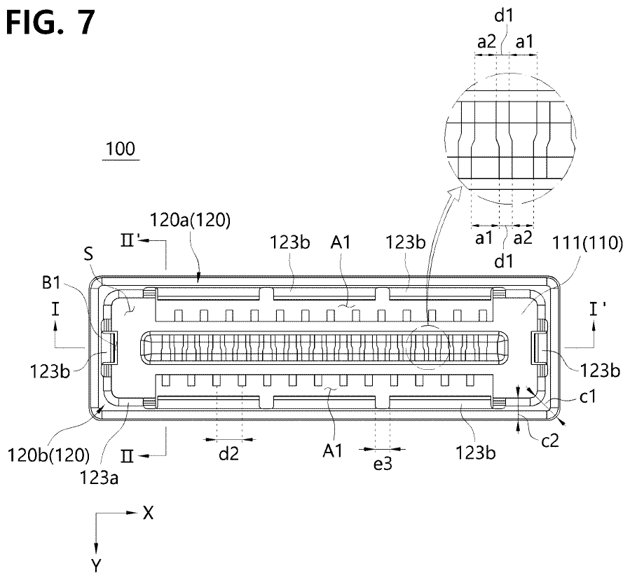

In this case, the plurality of plug contacts 130 are arranged in one row along the length of the plug insulator 110 in the first direction. In this case, the plug mount sections 134 of the plug contacts 130 arranged in one row are alternately arranged in a zigzag manner on both sides in a second direction of the island 113. In other words, the plug contacts 130 have a direction that is 180° opposite to that of the adjacent neighboring plug contacts 130 (see FIGS. 6 and 7).

In this way, the plug connector 100 is arranged in one row instead of two rows along the length of the first direction, and thus has an effect of reducing the overall width of the plug connector 100 while minimizing the arrangement gap d1 (FIG. 7) between adjacent to plug contacts 130 (ultra-narrow pitch), thereby enabling miniaturization.

Meanwhile, as the plug mount sections 134 are alternately arranged on both sides of the island 113 in the second direction in a zigzag manner, the mounter gap d2 (FIG. 7) between adjacent plug mount sections 134 is increased to prevent interference between the plug PCB patterns 400 (FIG. 20) on the substrate, that is, the plug contact patterns 410 (FIG. 20) to reduce the risk of short circuit.

Therefore, miniaturization of the receptacle connector 200 coupled to the plug connector 100 will also be possible.

In other words, the receptacle connector 200 includes a plurality of receptacle contacts 230 having the same structure.

At this time, the plurality of receptacle contacts 230 are arranged in one row along the length in the first direction on the receptacle bottom 211 of the receptacle insulator 210 so as to contact the plug contact 130 of the plug connector 100 to be coupled. In this case, the receptacle mount sections 235 of the receptacle contacts 230 arranged in one row are alternately arranged on both sides in a second direction of the receptacle bottom 211 in a zigzag manner. In other words, the receptacle contacts 230 have a direction that is 180° opposite to that of the adjacent neighboring receptacle contacts 230 (see FIGS. 14 and 16A).

In this way, the receptacle connector 200 may also reduce the overall width of the receptacle connector 200 while minimizing the arrangement gap d1′ (FIG. 16A) between adjacent to receptacle contacts 230 (ultra-narrow pitch), thereby enabling miniaturization, corresponding to the plug connector 100.

In addition, as the receptacle mount sections 235 are also alternately arranged on both sides of the receptacle bottom 211 in the second direction in a zigzag manner, the mounter gap d2′ (FIG. 7) between adjacent receptacle mount sections 235 is increased to prevent interference between the receptacle PCB patterns 300 (FIG. 19) on the substrate, that is, the receptacle contact patterns 310 (FIG. 19) to reduce the risk of short circuit.

As described above, the plug connector 100 and the receptacle connector 200 according to one embodiment of the present disclosure may be miniaturized by minimizing the gap between contacts (ultra-narrow pitch) and reducing the width of the entire connector since the plug contacts 130 and the receptacle contacts 230 are arranged in one row along the length in the first direction.

In this way, a miniaturization of the connector allows transmission of electrical signals without noise or loss without affecting other modules of the electronic device.

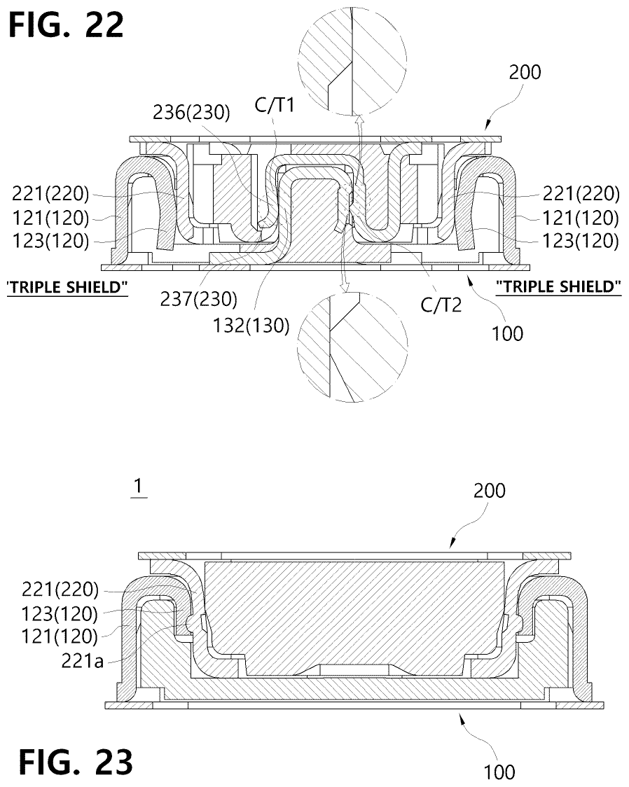

Meanwhile, the above-described plug contact 130 and the receptacle contact 230 constituting the plug connector 100 and the receptacle connector 200 according to an embodiment of the present disclosure are in contact while having a dual contact structure of a first contact area (C/T1) and a second contact area (C/T2) around the island 113 (see FIGS. 21 and 22).

Due to the dual contact structure, even if an external impact and an external force are applied while the plug connector 100 and the receptacle connector 200 are coupled with each other, the contact of one area may be continuously maintained, thereby not only increasing overall contact reliability but also maintaining stable signal transmission.

Meanwhile, the plug shield 120 of the plug connector 100 and the receptacle shield 220 of the receptacle connector 200 have a continuous shape without any discontinuous portion, that is, a disconnected portion or a seam portion, through a drawing method, and completely surround the circumference of the plug connector 100 and the receptacle connector 200, thereby enabling complete shielding.

When the plug connector 100 is coupled with the receptacle connector 200, the first shielding portion 121 and the second shielding portion 123 constituting the plug shield 120 of the plug connector 100 are coupled with the receptacle shielding portion 221 constituting the receptacle shield 220 of the receptacle connector 200 to have a triple shielding structure (see FIGS. 21 and 22).

The shielding performance of the connector 1 may be further improved according to the triple shielding structure.

Meanwhile, the receptacle shield 220 of the receptacle connector 200 may include embossed contact portion 221a or 221a′ protruding outwardly at a corner portion having a small deformation even by an external force, thereby improving contact stability and coupling force with the plug shield 120 (see FIG. 23).

In addition, the plug shield 120 may be prevented from being damaged and may stably guide the coupling (see FIG. 7) even when a first width c1 in a corner diagonal direction is formed to be long to strongly contact the receptacle shield 220 to be coupled.

In addition, since the plug shield 120 includes an elastically deformable movable piece 123b, the plug shield 120 may be stably coupled with the receptacle shield 220 while reducing an insertion force when the plug connector 100 and the receptacle connector 200 are coupled (see FIGS. 4 and 6).

The configuration of the plug connector 100 and the receptacle connector 200 will be described in more detail below.

### -Plug Connector-

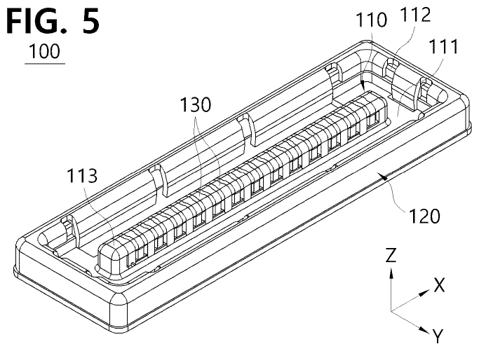

Hereinafter, referring to FIGS. 5 to 12, a plug insulator 110, a plug shield 120, and a plug contact 130 of the plug connector 100 constituting the connector 1 according to an embodiment of the present disclosure will be described in more detail.

As described above, the plug connector 100 according to an embodiment of the present disclosure may minimize a gap between contacts by arranging the plug contacts 130 in one row along a length on an island 113 the plug insulator 110 in a first direction (ultra-narrow pitch), thereby reducing the overall width of the plug connector 100 and enabling miniaturization.

In addition, the plug connector 100 may include the plug shield 120 having a continuous structure without a seam or a disconnection through a drawing method, thereby blocking noise and performing signal transmission without loss. In addition, it prevents damage from the external force and increases the coupling force while improving contact reliability.

To this end, the plug connector 100 according to an embodiment of the present disclosure includes a plug insulator 110 configured to be mounted on a substrate and coupled with the substrate, a plurality of plug contacts 130 configured to be coupled with the plug insulator 110 and mounted on the substrate, and a plug shield 120 configured to wrap around a circumference of the plug insulator 110 and implement a shielding structure (see FIG. 6).

First, the plug insulator 110 may be manufactured by insert molding, including the plug contact 130 with a non-conductive material. In addition, according to an embodiment, it is also possible to first manufacture the plug insulator 110 by injection molding or the like, and then assemble the plug contact 130 into the plug insulator 110. However, in the present disclosure, as one embodiment, unless otherwise described, it is assumed that it is manufactured through insert molding.

The plug insulator 110 includes a plug bottom plate 111, a plug sidewall 112, and a plug island 113.

The plug bottom plate 111 has a plate shape having a length in a first direction and a width in a second direction. Referring to FIG. 6, the plug bottom plate 111 may include a first plug bottom plate 111a and a second plug bottom plate 111b configured to extend without a break from the island 113 at both ends of the first direction side of the island 113 described below.

The width and length of the first plug bottom plate 111a and the second plug bottom plate 111b may be arbitrarily set as necessary.

Meanwhile, the plug bottom plate 111 provided on both ends of the first direction of the plug insulator 1110, that is, the first plug bottom plate 111a, the second plug bottom plate 111b, and the second direction length sidewall 112b of the plug sidewall 112 have a cut portion forming a separation length ell in the second direction and a separation width e12 in the first direction.

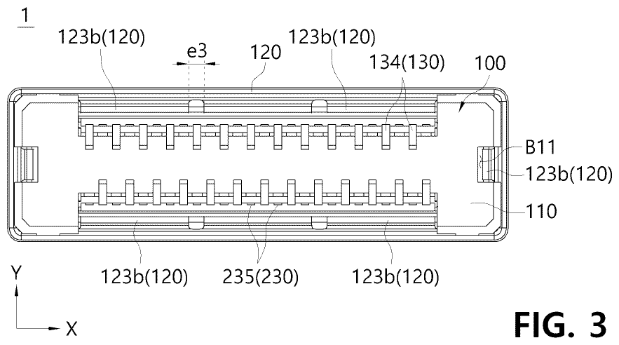

In this case, a space formed by the above-described separation length ell and the separation width e12 forms a displaceable shield displacement space B11 (referring to FIGS. 3 and 6) of the movable piece 123b of the plug shield 120 described below provided on both ends in the first direction when the movable piece 123b of the plug shield 120 is coupled to the receptacle connector 200, so as to be coupled while elastically pressing the receptacle shielding portion 221 of the receptacle shield 220.

Meanwhile, a plug bottom plate 111 and a first direction length side wall 112a of the plug sidewall 112 provided on both sides of the plug insulator 110 in the second direction have a portion forming a space length e21 in the first direction and a space width e22 in the second direction.

In this case, the space length e21 and the space width e22 described above provide a displaceable space of the movable piece 123b constituting the plug shield 120 and form a first inspection window Al on both sides in the second direction to visually confirm the mounting state of the plug mount section 134 constituting the plug contact 130 (see FIGS. 6 and 7).

Meanwhile, as shown in FIG. 6, the plug sidewall 112 has an extended shape with a height in the third direction along the circumference of the plug bottom plate 111.

In this case, the plug sidewall 112 may be arranged in the second direction of the plug bottom plate 111 and include a first direction length sidewall 112a having a length in the first direction and a second direction length sidewall 112b having a length in the second direction, and the plug sidewall 112 may be configured to have a cut or penetrated hole shape as necessary.

Meanwhile, the plug sidewall 112 may have a shield seating protrusion 112c formed along an inner surface, on which an end 123a-2 of the fixing piece 123a of the plug shield 120 is seated, so that the plug shield 120 described below may be stably coupled (see FIG. 6).

Meanwhile, the plug sidewall 112 may further form a pressing protrusion 112a-1 (FIG. 6) protruding outwardly from the first direction length sidewall 112a to increase the coupling force while pushing and pressing the plug shield 120 to be coupled.

The pressing protrusion 112a-1 increases the coupling force while pressing the inner wall surface of the first shield portion 121 of the plug shield 120 to be coupled, thereby allowing the plug shield 120 and the plug insulator 110 to be firmly coupled together.

And, the island 113 has a shape that extends in the first direction to the plug bottom plate 111 and protrudes in the third direction. The island 113 is inserted into the receiving groove S1 of the receptacle connector 200 (FIG. 14) so that the plug contact 130, thereby causing the plug contact 130 and the receptacle contact 230 to come into contact with each other.

Subsequently, the plug shield 120 has a continuous shape without a seam or a break through a drawing method with a conductive material.

The plug shield 120 is coupled with the plug insulator 110 by wrapping around the circumference thereof and is mounted on the substrate through the shield pattern 420 (FIG. 20) of the plug PCB pattern 400 to ground.

Specifically, the plug shield 120 includes a plurality of first plug shields 120a arranged on a rim of the plug insulator 110 in the first direction or the second direction, and a plurality of second plug shields 120b arranged on the corners of the plug insulator 110 while connecting the first plug shields 120a without a break.

The first plug shield 120a and the second plug shield 120b are arbitrarily separated to separate the areas where they are arranged, and substantially, the first plug shield 120a and the second plug shield 120b will be an integral shape that is continuous without a break through the drawing method.

Meanwhile, a first width c1 of the second plug shield 120b in the corner diagonal direction is configured to be greater than a second width c2 of the first plug shield 120a in the first direction or the second direction (see FIG. 7).

As described above, as the first width c1 of the second plug shield 120b is configured to be longer, the strength of the corner is increased, and accordingly, even if an impact occurs when the plug connector 100 and the receptacle connector 200 are coupled with each other, damage is prevented and the receptacle connector 200 may be stably guided.

In other words, as shown in FIG. 4, when the receptacle connector 200 is coupled while being received in the receiving space S of the plug connector 100, a portion where the receptacle connector 200 collides or comes into contact with the most frequently is the corner portion, that is, the portion of the second plug shield 120b. Accordingly, when the first width c1 of the second plug shield 120b is configured to be thick, damage may be prevented even during contact for frequent coupling.

In addition, the receptacle connector 200 may be coupled by pushing it to the plug connector 100 using the second plug shield 120b as a guide, so that the coupling may be easily performed.

Meanwhile, as described in detail above, the plug connector 100 and the receptacle connector 200 of the present disclosure have a triple shielding structure when coupled.

To this end, the first plug shield 120a and the second plug shield 120b include a first shielding portion 121, an upper coupling portion 122, and a second shielding portion 123 (see FIGS. 6, 21, and 22).

First, the first shielding portion 121 has a shape that wraps around the outer circumference of the plug insulator 110 without a break while having a height in the third direction.

And, the upper coupling portion 122 has a shape in which the third direction upper side end of the first shielding portion 121 extends continuously without a break while covering the upper surface of the plug sidewall 112.

And, the second shielding portion 123 has a shape in which the upper coupling portion 122 is bent to be rounded downward in the third direction and is continuously formed without a break, wrapping around an inner circumference of the plug insulator 110.

The first shielding portion 121 and the second shielding portion 123 constituting the plug shield 120 of the plug connector 100 are arranged adjacent to the receptacle shielding portion 221 provided in the receptacle shield 220 of the receptacle connector 200 to be coupled with each other in the first direction, the second direction, and the corner direction to form a triple shielding structure.

This triple shielding structure facilitates signal transmission when the plug connector 100 and the receptacle connector 200 are coupled, and blocks external noise to allow electrical signals to be transmitted without noise or loss.

Meanwhile, the plug shield 120 includes a plug shield mounter 124 in which the lower end of the first shield 121 in the third direction is bent outward and extended to be continuous without a break.

The plug shield mounter 124 is mounted on the substrate and grounded through the plug shield pattern 420 constituting the plug PCB pattern 400, thereby increasing the mounting force between the plug connector 100 and the module substrate (not shown) (see FIGS. 6 and 20).

Meanwhile, preferably, the height h1 of the plug shield 120 (FIG. 6) is equal to or longer than the height h2 of the island 113 (FIG. 6). Through this, the side of the plug connector 100 may be completely shielded.

Meanwhile, referring again to FIGS. 5 to 12, the second shielding portion 123 constituting the plug shield 120 is composed of a fixing piece 123a configured to be in contact with and fix the receptacle shield 220 of the receptacle connector 200 when coupled with the receptacle connector 200 in a fixed form without elasticity, and a movable piece 123b configured to contact and fix the receptacle shield 220 of the receptacle connector 200 while pressing the receptacle shield 220 using an elastic force when coupled with the receptacle connector 200 in an elastically deformable form.

The fixing piece 123a has a shape that is bent downward in the third direction and extended from the upper coupling portion 122 of the plug shield 120 described above.

The movable piece 123b is bent downward from the upper coupling portion 122 of the plug shield 120 in the third direction, and is disposed to be spaced apart from the fixing piece 123a by a cutoff gap e3 (FIG. 7), and is pressed and elastically deformable according to the coupling of the receptacle connector 200.

Preferably, the fixing piece 123a is arranged on the second plug shield 120b, that is, at a corner portion so as to allow stable coupling.

And, preferably, the movable piece 123b is arranged on both sides of the second direction and both ends of the first direction adjacent to the fixing piece 123a, and presses the receptacle shield 220 to be engaged using the elastic force.

If the plug shield 120 is formed of only the fixing piece 123a which is not bent easily on the slope of the plug shield 120, excessive insertion force may be generated to couple the plug shield 120 and the receptacle shield 220.

However, as the movable piece 123b having the elastic force is provided as described above, the movable contact structure using the elastic force may reduce the insertion force for coupling the plug shield 120 and the receptacle shield 220. Accordingly, the user may easily couple the plug connector 100 and the receptacle connector 200.

In other words, the movable piece 123b of the plug shield 120 may prevent excessive insertion force from occurring.

Meanwhile, preferably, referring to FIGS. 10 and 12, the above-described upper-side guide contact 123a-1 of the fixing piece 123a is configured to protrude toward the island 113 than the upper-side movable contact 123b-1 of the movable piece 123b.

Accordingly, when the receptacle connector 200 is coupled to the plug connector 100, the upper-side guide contact 123a-1 of the fixing piece 123a come into contact with the receptacle connector 200 earlier than the upper-side movable contact 123b-1 of the movable piece 123b.

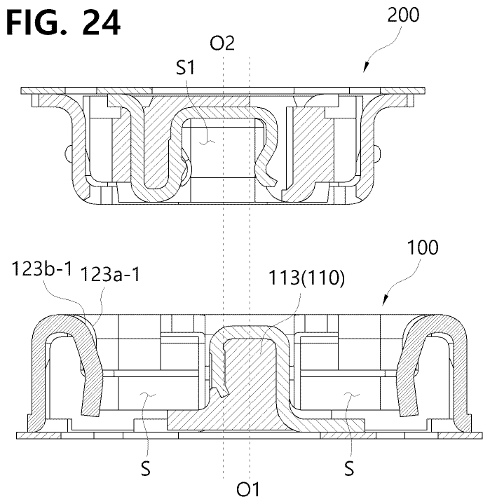

Referring to FIGS. 24 to 26, when the plug connector 100 and the receptacle connector 200 are coupled, the center O1 of the plug connector 100 and the center O2 of the receptacle connector 200 are not aligned with each other.

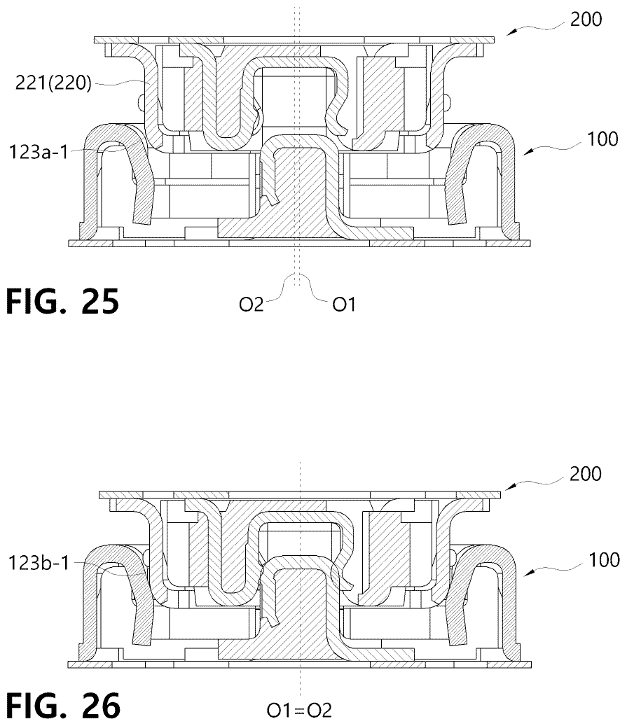

When the plug connector 100 and the receptacle connector 200 are coupled at the position of FIG. 24, as in FIG. 25, the receptacle connector 200 first comes into contact with the upper-guide contact portion 123a-1 of the fixing piece 123a of the second shielding portion 123.

Thereafter, the receptacle connector 200 is slidably coupled to make contact with the upper-side movable contact 123b-1 of the movable piece 123b, and the center O1 of the plug connector 100 and the center O2 of the receptacle connector 200 may be aligned and stably coupled with each other as shown in FIG. 26.

In addition, as described above, the upper-side guide contact 123a-1 of the fixing piece 123a protrudes toward the island 113 than the upper-side movable contact 123b-1 of the movable piece 123b, so that the receptacle connector 200 first comes into contact with the fixed fixing piece 123a, so that the fixing piece 123a may guide the receptacle connector 200 and perform an alignment function.

Meanwhile, the movable piece 123b forms a protruding contact 123b-2 that is bent at the lower side and protrudes toward the island 113 (see FIGS. 10 and 12).

According to the coupling of the receptacle connector 200, the protruding contact 123b-2 of the movable piece 123b elastically pushes and presses the receptacle shielding portion 221 of the receptacle shield 220 so that the plug connector 100 and the receptacle connector 200 are stably coupled (see FIG. 21).

The plug connector 100 and the receptacle connector 200 according to the present disclosure are ultra-small connectors whose sizes are 1 cm or less in length and width. For example, the contact may have a length of 7.5 mm, a width of 2.0 mm, a height of 0.6 mm, and a pitch between contacts of 0.175 mm.

In such an ultra-small connector, it is very difficult for a worker to visually check the plug connector 100 and the receptacle connector 200 and couple (engaging).

However, as described above, the fixing piece 123a serves as an alignment role while guiding the receptacle connector 200, and the movable piece 123b serves as a function of decreasing an insertion force by using an elastic force, so that the worker may easily couple the plug connector 100 and the receptacle connector 200.

Such a fine design structure including the fixing piece 123a and the movable piece 123b may increase the completeness of the product (connector).

Continuing, referring again to FIGS. 5 to 12, the plug contact 130 constituting the plug connector 100 according to an embodiment of the present disclosure has a structure in which a plurality of the plug connectors 100 are arranged in one row in the first direction on the island 113 as described above.

Through this, the plug contact 130 has an ultra-narrow pitch while reducing the width of the plug connector 100 to miniaturize it.

For example, the plug contact 130 has a fixed shape that is not elastically deformed.

A plurality of fixed plug contacts 130 are arranged in one row having a pitch of an arrangement gap d1 on the island 113 of the plug insulator 110 in the first direction,

At this time, the plug mount section 134 mounted on the substrate has a mounter gap d2 and is arranged on both sides of the island 113 in the second direction in a zigzag manner, and is configured to be exposed from a bottom surface of the plug bottom plate 111;

In other words, the plug contacts 130 have a direction that is 180° opposite to that of the adjacent neighboring plug contacts 130.

The plug mount section 134 exposed in a zigzag manner is mounted on the substrate through the plug contact pattern 410 of the plug PCB pattern 400, thereby increasing the mounting force between the plug connector 100 and the substrate.

Meanwhile, the plug contact pattern 410 described above is arranged so that each does not interfere with each other according to the zigzag arrangement of the plug mount section 134 and the mounter gap d2.

In addition, the plug contact pattern 410 may be configured at a location where it does not interfere with the plug shield pattern 420 for mounting the plug shield 120 (see FIG. 20).

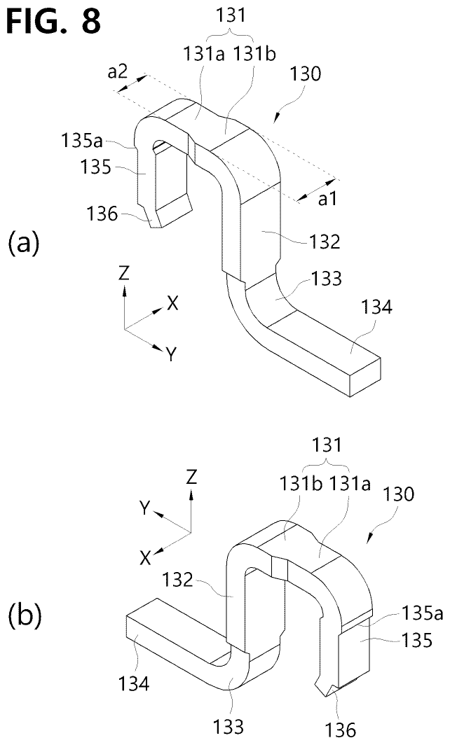

Meanwhile, for example, referring to FIG. 8, the plug contact 130 has a bar shape having a length in the second direction.

And, the plug contact 130 includes an upper contact section 131, a first-side contact section 132, a first molding fixing section 133, a plug mount section 134, a second-side contact section 135, and a second molding fixing section 136.

This plug contact 130 is configured integrally by insert molding into the plug insulator 110.

The upper contact section 131 of the plug contact 130 has a shape exposed to the outside while warping around the upper surface of the island 113, and includes a first width upper contact section 131a having a first width a1 and a second width upper contact section 131b having a second width a2 narrower than the first width a1 and extending from the first width upper contact section 131a.

The plug contact 130 is arranged in one row having a pitch of an arrangement gap d1 in a first direction on the island 113.

In this way, since the widths of the upper contact sections 131 are different from each other, an ultra-narrow pitch arrangement gap d1 may be implemented while the direction of the plug mount sections 134 may be arranged in a zigzag manner on both sides of the second direction.

And, the plug contacts 130 are arranged while having a direction that is 180° opposite to that of the adjacent neighboring plug contact to each other, so that the mounter gap d2 between the plug mount sections 134 may be increased while the arrangement gap d1 is maintained constant.

Accordingly, the plug contact pattern 410 is disposed so that each does not interfere with each other according to the zigzag arrangement of the plug mount section 134 and the mounter gap d2 (see FIGS. 7 and 20).

Referring again to FIG. 8, the first-side contact section 132 has a shape in which one end of the upper contact section 131, that is, the end of the second width upper contact section 131b described above, is bent and extended downward in the third direction and is exposed to the wall surface of the island 113 in the second direction.

In addition, the first molding fixing section 133 has a shape in which an end of the first-side contact section 132 is bent and extended in the second direction and is fixed by insert molding to the plug bottom plate 111. The first molding fixing section 133 is connected to the plug mount section 134.

Meanwhile, the above-described plug mount section 134 has a shape in which the first-side contact section 132 extends in the second direction and is exposed on the bottom surface of the plug bottom plate 111 and a portion thereof is configured to protrude outwardly in the second direction of the plug bottom plate 111. In this case, the plug mount section 134 may have a shape in which the first molding fixing section 133 described above is extended.

The second-side contact section 135 has a shape in which the other end of the upper contact section 131, that is, an end of the first width upper contact section 131a, is bent downward in the third direction while forming the plug protruding contact 135a and extends and exposed to the wall surface of the island 113 in the second direction.

And, the second molding fixing section 136 has a shape in which an end of the second-side contact section 135 is bent and extends in the third direction, and is insert-molded into the island 113.

Referring again to FIGS. 21 and 22, the first-side contact section 132 constituting the plug contact 130 comes into contact with the elastic contact section 237 of the movable receptacle contact 230 provided in the receptacle connector 200 on the wall surface in the second direction of the island part 113 to form a first contact area C/T1.

And, the section-side contact section 135 constituting the plug contact 130 is in contact with the fixing contact section 232 or the fixing contact protrusion 232a of the movable receptacle contact 230 provided in the receptacle connector 200 to form a second contact area C/T2.

In this case, the first contact area C/T1 and the second contact area C/T2 are alternately formed on one side wall surface and the other side wall surface of the island 113 in the second direction.

Meanwhile, the plug protruding contact 135a has a shape in which it is in contact with the fixing contact section 232 of the movable receptacle contact 230 provided in the receptacle connector 200 and is included in a portion of the second contact area C/T2.

As described above, since the plug contact 130 has a dual contact structure with the receptacle contact 230 to be described below, the contact of any one area is maintained even in the occurrence of an impact due to the coupling of the plug connector 100 and the receptacle connector 200, thereby increasing the reliability of the contact of the entire connector.

### -Receptacle Connector-

Hereinafter, with reference to FIGS. 13 to 18, a receptacle insulator 210, a receptacle shield 220, and a receptacle contact 230 of a receptacle connector 200 constituting a connector 1 of an embodiment of the present disclosure will be described in more detail.

As described above, the receptacle connector 200 according to an embodiment of the present disclosure may be reduced in width to a size corresponding to the plug connector 100 so as to be coupled with the plug connector 100 having an ultra-narrow pitch structure, thereby enabling miniaturization.

In addition, the receptacle connector 200 may include the receptacle shield 220 having a continuous structure without a seam or a disconnection through a drawing method, thereby blocking noise and performing signal transmission without loss. In addition, it prevents damage from the external force and increases the coupling force while improving contact reliability.

To this end, the receptacle connector 200 according to an embodiment of the present disclosure includes a receptacle insulator 210 configured to be mounted on a substrate and coupled with the substrate, a plurality of receptacle contacts 230 configured to be coupled with the receptacle insulator 210 and mounted on the substrate, and a receptacle shield 220 configured to wrap around a circumference of the receptacle insulator 210 and implement a shielding structure (see FIG. 14).

First, the receptacle insulator 210 may be manufactured by insert molding, including the receptacle contact 230 with a non-conductive material. In addition, according to an embodiment, it is also possible to first manufacture the receptacle insulator 210 by injection molding or the like, and then assemble the receptacle contact 230 into the receptacle insulator 210. However, in the present disclosure, as one embodiment, unless otherwise described, it is assumed that it is manufactured through insert molding.

This receptacle insulator 210 includes a receptacle bottom 211 and a receptacle retaining wall 212.

The receptacle bottom 211 has a shape having a length and a width that may be seated while the island 113 of the plug connector 100 is coupled with it.

And, the receptacle retaining wall 212 is sized and shaped to be received on the receiving space S of the plug connector 100, and extends along a circumference of the receptacle bottom 211 with a height in the third direction to form a receiving groove S1 inward of the receptacle connector 200 such that the island 113 of the plug connector 100 is received.

Meanwhile, the receptacle shield 220 is manufactured through a drawing method to have a continuous shape without a break with a conductive material.

The receptacle shield 220 is coupled with the substrate to warp around the circumference of the receptacle insulator 210 and mounted on it.

For example, the receptacle shield 220 includes a plurality of first receptacle shields 220a arranged on a rim of the receptacle insulator 210 in the first direction or the second direction, and a second receptacle shield 220b arranged on a corner of the receptacle insulator 210 while connecting the first receptacle shields 220a without a seam or a break (see FIG. 14).

Such a receptacle shield 220 is mounted on the substrate through the receptacle shield pattern 320 (FIG. 19) of the receptacle PCB pattern 300 to ground.

The first receptacle shield 220a and the second receptacle shield 220b described above are arbitrarily separated to separate the areas where they are arranged, and substantially, the first receptacle shield 220a and the second receptacle shield 220b will be an integral shape that is continuous without a break through the drawing method.

Meanwhile, as described in detail above, the plug connector 100 and the receptacle connector 200 of the present disclosure have a triple shielding structure when coupled.

To this end, the first receptacle shield 220a and the second receptacle shield 220b include a receptacle shielding portion 221 (see FIGS. 14, 21 and 22).

The receptacle shielding portion 221 has a shape that wraps around the outer circumference of the receptacle insulator 210 without a break while having a height in the third direction.

The receptacle shielding portion 221 constituting the receptacle shield 220 of the receptacle connector 200 is arranged adjacent to the first shielding portion 121 and the second shielding portion 123 provided in the plug shield 120 of the plug connector 100 to be coupled with each other to form a triple shielding structure.

This triple shielding structure facilitates signal transmission when the plug connector 100 and the receptacle connector 200 are coupled, and blocks external noise to allow electrical signals to be transmitted without noise or loss.

Meanwhile, the second receptacle shield 220b includes a receptacle corner coupling portion 222 in which the third direction upper end of the receptacle shielding portion 221 is continuous without a break while covering the corner of the receptacle retaining wall 212.

The rigidity of the receptacle shield 220 is further reinforced through the receptacle corner coupling portion 222. In other words, the rigidity is reinforced so that the receptacle shield 220 does not bend or damaged even when an external force is generated when the receptacle shield 220 is coupled with the receptacle insulator 210 or coupled with the plug connector 100.

Meanwhile, the receptacle shield 220 includes a receptacle shield mounter 223 in which the lower end of the third direction of the receptacle shield portion 221 is bent outward and extended to be continuous without a break.

The receptacle shield mounter 223 is mounted on the substrate and grounded through the receptacle shield pattern 320 constituting the receptacle PCB pattern 300, thereby increasing the mounting force between the receptacle connector 200 and the module substrate (not shown) (see FIGS. 14 and 19).

Meanwhile, the receptacle shielding portion 221 has a height that can completely cover the side of the receptacle retaining wall 212, and through this, the side of the receptacle connector 200 may be completely shielded.

Meanwhile, referring again to FIG. 16(a)(b) to 23, the receptacle shielding portion 221 constituting the receptacle shielding member 220 has a fixed structure that is not deformed by an external force and includes an embossed contact portion 221a protruding outwardly in the first or second direction at a corner portion, that is, on the side of the second receptacle shield 220b ((a) of FIG. 16B).

In another example, the receptacle shielding portion 221 includes an embossed contact portion 221a′ protruding outwardly while wrapping around a corner of the second receptacle shield 220b ((b) of FIG. 16B).

The embossed contact portion 221a or 221a′ is coupled with the second shielding portion 123 of the plug shield 120 by pushing and pressing it when the plug connector 100 and the receptacle connector 200 are coupled with each other. Accordingly, the coupling force and the contact ability of the plug shield 120 and the receptacle shield 220 may be improved, and thus the shielding performance may be further improved.

Meanwhile, referring again to FIGS. 24 to 26, when the plug connector 100 and the receptacle connector 200 are coupled with each other, the coupling is often performed in a state in which a center O1 of the plug connector 100 and a center O2 of the receptacle connector 200 are not aligned with each other.

When the plug connector 100 and the receptacle connector 200 are coupled at the position of FIG. 24, as in FIG. 25, the receptacle shielding portion 221 constituting the receptacle shield 220 of the receptacle connector 200 first comes into contact with the upper guide contact portion 123a-1 of the fixing piece 123a of the second shielding portion 123 constituting the plug shield portion 120.

Then, the receptacle connector 200 is coupled in a sliding manner and comes into contact with the upper movable contact portion 123b-1 of the movable piece 123b, and the center O1 of the plug connector 100 and the center O2 of the receptacle connector 200 are aligned as in FIG. 26, and a stable coupling may be achieved.

Next, referring again to FIGS. 13 to 23, the receptacle contact 230 constituting the receptacle connector 200 according to an embodiment of the present disclosure has a structure in which a plurality of the receptacle contacts 230 are arranged in one row in the first direction on the receptacle bottom 211 the receptacle insulator 210 as described above.

The arrangement of the receptacle contacts 230 corresponds to the plug contacts 130 having an ultra-narrow pitch structure arranged on the island 113 of the plug connector 100, and the plug contacts 130 corresponding to these are arranged in one row, so that the receptacle contacts 130 may have the ultra-narrow pitch structure.

Through this, the width of the receptacle connector 100 may be reduced while forming the ultra-narrow pitch, thereby miniaturizing it.

Meanwhile, for example, the receptacle contact 230 has a movable shape that is elastically deformable, unlike the fixed plug contact 130. In other words, one side of the receptacle contact 230 has a structure capable of increasing a contact force by pressing the plug contact 130 using elasticity.

As a specific example, as shown in FIGS. 14 and 16(a), a plurality of movable receptacle contacts 230 are arranged in one row with a pitch of an arrangement gap d1′ in the first direction on the receptacle bottom 211 of the receptacle insulator 210.

At this time, the receptacle mount section 235 mounted on the substrate has a mounter gap d2′ and is formed to be exposed from the bottom surface of the receptacle bottom 211 while being arranged in a zigzag manner on both sides in the second direction.

In other words, the receptacle contacts 230 have a direction that is 180° opposed to that of adjacent neighboring receptacle contacts 230.

The receptacle mount section 235 exposed in a zigzag manner is mounted on the substrate through the receptacle contact pattern 310 of the receptacle PCB pattern 300, thereby increasing the mounting force between the receptacle connector 200 and the substrate.

Meanwhile, the receptacle contact pattern 310 described above is arranged so that each does not interfere with each other according to the zigzag arrangement of the receptacle mount section 235 and the mounter gap d2′.

In addition, the receptacle contact pattern 310 may be configured at a location where it does not interfere with the receptacle shield pattern 320 for mounting the receptacle shield 220 (see FIG. 19).

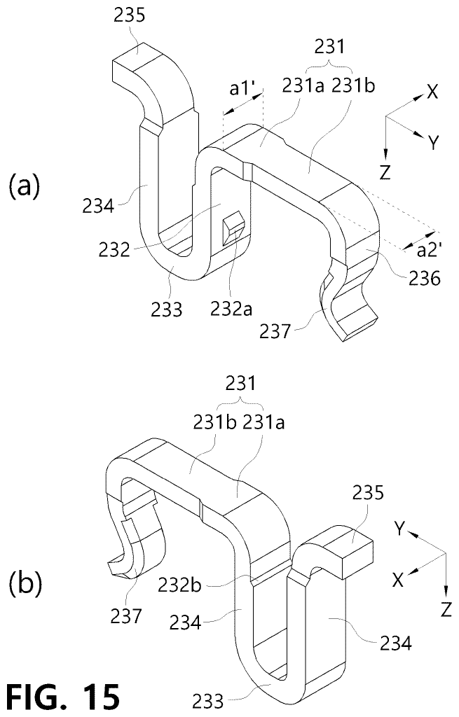

Meanwhile, for example, referring to FIG. 15, the receptacle contact 230 has a bar shape having a length in the second direction.

And, the receptacle contact 230 includes a bottom contact section 231, a fixing contact section 232, a retaining wall fixing section 233, a molding fixing section 234, a receptacle mount section 235, an elastic arm section 236 and an elastic contact section 237.

The receptacle contact 230 is configured integrally by insert molding into the receptacle insulator 210.

The bottom contact section 231 of the receptacle contact 230 is configured to be exposed on the upper surface of the receptacle bottom 211 and includes a first width bottom contact section 231a having a first width a1′ and a second width bottom contact section 231b having a second width a2′ narrower than the first width a1′ and extending from the first width bottom contact section 231a.

The above-described bottom contact section 231 has a shape corresponding to the upper contact section 131 of the plug contact 130.

In other words, the bottom contact section 231 of the receptacle contact 230 are arranged in one row with a pitch of an arrangement gap d1′ in the first direction on the receptacle bottom 211 corresponding to the upper contact section 131 of the plug contact 130.

And, the receptacle contacts 230 adjacent to each other are arranged in one row by turning the receptacle contacts 230 by 180° in a different direction of the receptacle mount section 235.

In this way, since the widths of the bottom contact sections 231 are different from each other, the ultra-narrow pitch is implemented while maintaining the ultra-narrow pitch arrangement gap d1′ and the receptacle contact pattern 310 is arranged so that each does not interfere with each other according to the zigzag arrangement of the receptacle mount sections 235 and the mounter gap d2′ (see FIG. 15, FIG. 16(a) and FIG. 19).

Referring again to FIG. 15, the fixing contact section 232 has a shape in which one end of the bottom contact section 231, that is, the end of the first width bottom contact section 231a is bent and extended upward in the third direction and is exposed on one side wall of the receptacle retaining wall 212, and the fixing contact protrusion 232a protrudes from one side thereof.

And, the retaining wall fixing section 233 has a shape in which an end of the fixing contact section 232 extends to cover the upper surface of the receptacle retaining wall 212 and is exposed.

The molding fixing section 234 has a shape in which the end of the retaining wall fixing section 233 is bent downward in the third direction and extended to be insert-molded into the receptacle retaining wall 212.

The receptacle mount section 235 has a shape in which the molding fixing section 234 is exposed on the bottom surface of the receptacle retaining wall 212 while extending in the second direction, and a portion thereof protrudes outwardly in the second direction of the receptacle retaining wall 212.

The elastic arm section 236 has a shape in which the other end of the bottom contact section 231, that is, an end of the second width bottom contact section 231b extends, is arranged in the displacement space B12 of the receptacle retaining wall 212, and is bent upward in the third direction to extend.

Meanwhile, the elastic contact section 237 has a shape in which an end of the elastic arm section 236 extends in the third direction and is bent to be rounded, and an end thereof faces the receptacle retaining wall 212.

And, the receptacle retaining wall 212 forms a contact displacement space B12 (FIG. 16A) through which the elastic contact section 237 is elastically deformable.

Referring again to FIGS. 21 and 22, the elastic contact section 237 constituting the receptacle contact 230 comes into contact with the first-side contact section 132 of the plug contact 130 provided in the plug connector 100 on the wall surface of the island 113 in the second direction of the plug connector 100 to form a first contact area C/T1.

And, the fixing contact section 232 is in contact with the section-side contact section 135 or the plug protruding contact 135a of the plug contact 130 provided in the plug connector 100 on the wall surface of the island 113 in the second direction of the plug connector 100 to form a second contact area C/T2.

In this case, the first contact area C/T1 and the second contact area C/T2 are alternately formed on one side wall surface and the other side wall surface of the island 113 in the second direction.

Meanwhile, the fixing contact protrusion 232a has a structure in which it is in contact with the second-side contact section 135 of the plug contact 130 provided in the plug connector 100 and is included in a portion of the second contact area C/T2.

As described above, since the plug contact 130 has a dual contact structure with the receptacle contact 230 to be described below, the contact of any one area is maintained even in the occurrence of an impact due to the coupling of the plug connector 100 and the receptacle connector 200, thereby increasing the reliability of the contact of the entire connector.

### -Coupled Connector of Plug Connector and Receptacle Connector-

As described above, the plug connector 100 and the receptacle connector 200 constituting the connector 1 according to an embodiment of the present disclosure may be miniaturized by minimizing an arrangement gap d1 or d1′ between contacts while reducing the overall width of the connector by arranging a plurality of plug contacts 130 in one row along a length in a first direction on an island 113 of a plug insulator 110 and a plurality of receptacle contacts 230 in one row along a length in the first direction on a receptacle bottom 211 of a receptacle insulator 210.

In addition, since the plug mount section 134 and the receptacle mount section 235 are arranged in a zigzag manner on both sides in the second direction, gaps between the adjacent mounters may be increased to prevent interference between the PCB patterns 400 and 300 on the substrate, thereby reducing the risk of short circuit.

The miniaturization of the plug connector 100 and the receptacle connector 200 to be coupled may allow transmission of electrical signals without noise or loss without affecting other modules of the electronic device.

Meanwhile, the plug contact 130 and the receptacle contact 230 have a dual contact structure in which the first contact area C/T1 and the second contact area C/T2 are alternately formed and contacted around the island 113 of the plug connector 100, which may increase the signal transmission rate and also increase the overall contact reliability by maintaining the contact of any one area even under external force.

Further, the plug connector 100 includes a plug shield 120 wrapping around a circumference of the plug insulator 110 in a continuous shape without a seam or a break through a drawing method, and the receptacle connector 200 includes a receptacle shield 220 wrapping around a circumference of the receptacle insulator 210 in a continuous shape without a seam or a break through a drawing method, so that the plug contact 130 and the receptacle contact 230 may be completely disconnected from the outside, thereby enabling complete shielding.

In addition, when the plug connector 100 and the receptacle connector 200 are coupled with each other, a first shielding portion 121 and a second shielding portion 123 of the plug shield 120 and a receptacle shielding portion 221 of the receptacle shield 220 may form a triple shielding structure, thereby maximizing shielding performance.

In addition, the plug shield 120 may be stably coupled with the receptacle shield 220 to be coupled by including a fixed member 123a whose position is fixed and an elastically deformable movable piece 123b.

In addition, the plug shield 120 may be prevented from being damaged and may stably guide the coupling even when a first width c1 in a corner diagonal direction is formed to be long to strongly contact the receptacle shield 220 to be coupled.

Further, the receptacle shield 220 may include embossed contact portion 221a or 221a′ protruding outwardly at a corner portion having a small deformation even by an external force, thereby improving contact stability and coupling force with the plug shield 120.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

1. A plug connector coupled with a receptacle connector comprising:
a plug insulator including:
a plug bottom plate configured to have a length in a first direction and a width in a second direction,
a plug sidewall configured to extend along a circumference of the plug bottom plate and have a height in a third direction to define a receiving space S in which the receptacle connector is received, and
an island configured to have a length in the first direction and protrude in the third direction on the plug bottom plate;
a plug shield configured to be coupled with the plug insulator by wrapping around a circumference thereof and mounted on a substrate; and
a plurality of plug contacts configured to be arranged in one row having a pitch of an arrangement gap d1 on the island in the first direction, plug mount sections thereof mounted on the substrate each having a mounter gap d2 and being arranged on both sides of the island in the second direction in a zigzag manner, and being exposed from a bottom surface of the plug bottom plate, wherein the plug shield including:
a first shielding portion configured to wrap around an outer circumference of the plug insulator,
an upper coupling portion configured to cover an upper surface of the plug sidewall and continuous without a break, and
a second shielding portion configured to wrap around an inner circumference of the plug insulator
wherein the second shielding portion includes:
a fixing piece configured to be bent downward from the upper coupling portion in the third direction, and
a movable piece configured to be bent downward from the upper coupling portion in the third direction and be arranged to be spaced apart from the fixing piece by a cutoff gap e3 and be elastically deformable according to coupling with the receptacle connector.

2. The plug connector of claim 1, wherein an upper-side guide contact of the fixing piece is configured to protrude toward the island than an upper-side movable contact of the movable piece.

3. The plug connector of claim 2, wherein the movable piece further defines a protruding contact configured to be bent at a lower side and protrude toward the island.

4. The plug connector of claim 1, wherein the plug shield includes:
a plurality of first plug shields arranged on a rim of the plug insulator in the first direction or the second direction, and
a second plug shield arranged on corners of the plug insulator while connecting the first plug shields without a break, and
wherein a first width c1 of the second plug shield in the corner diagonal direction is configured to be greater than a second width c2 of the first plug shield in the first direction or the second direction.

5. The plug connector of claim 4, wherein the first plug shield and the second plug shield each include:
the first shielding portion configured to wrap around the outer circumference of the plug insulator without a break while having a height in the third direction,
the upper coupling portion configured such that the third direction upper-side end of the first shielding portion extends continuously without a break while covering the upper surface of the plug sidewall, and
the second shielding portion configured such that the upper coupling portion is bent to be rounded downward in the third direction and continuous without a break, while wrapping around the inner circumference of the plug insulator.

6. The plug connector of claim 1, wherein the plug bottom plate and a first direction length side wall of the plug sidewall provided on both sides of the plug insulator in the second direction defines a space length e21 in the first direction and a space width e22 in the second direction, thereby providing a displaceable space of the movable piece of the plug shield, while forming a first inspection window A1 for confirming a mounting state of the plug mount section 134 of the plug contact.

7. The plug connector of claim 1, wherein the plug bottom plate provided on both ends of the first direction of the plug insulator, and a second direction length sidewall of the plug sidewall defines a separation length e11 in the second direction and a separation width e12 in the first direction, thereby forming a displaceable shield displacement space B11 of the movable piece of the plug shield.

8. The plug connector of claim 1, wherein a height h1 of the plug shield is configured to be equal to or longer than a height h2 of the island.

9. The plug connector of claim 1, wherein each of the plug contacts has a bar shape having a length in the second direction, and includes:
an upper contact section configured to be exposed while wrapping around an upper surface of the island,
a first-side contact section configured such that one end of the upper contact section is bent and extended downward in the third direction and is exposed to the wall surface of the island in the second direction,
a plug mount section configured such that the first-side contact section extends in the second direction and is exposed from the bottom surface of the plug bottom plate and a portion thereof protrudes outwardly in the second direction of the plug bottom plate, and
a section-side contact section configured such that the other end of the upper contact section is bent downward in the third direction while forming a plug protruding contact and extends and exposed to the wall surface of the island in the second direction.

10. The plug connector of claim 9, wherein the upper contact section includes:
a first width upper contact section configured to have a first width a1, and
a second width upper contact section configured to have a second width a2 narrower than the first width a1 and extend from the first width upper contact section.

11. The plug connector of claim 9, wherein each of the plug contacts includes:
a first molding fixing section configured such that an end of the first-side contact section is bent in the second direction and is connected to the plug mount section and is insert molded into the plug bottom plate, and
a second molding fixing section configured such that an end of the second-side contact section is bent and extends in the third direction, and is insert-molded into the island.

12. A receptacle connector coupled with the plug connector comprising:
a receptacle insulator received in a receiving space S of the plug connector, including:
a receptacle bottom and
a receptacle retaining wall configured to extend along a circumference of the receptacle bottom and have a height in a third direction to form a receiving groove S1 in which an island of the plug connector is received;
a receptacle shield coupled with while warping around a circumference of the receptacle insulator and mounted on a substrate, including:
a plurality of first receptacle shields configured to be arranged on a rim of the receptacle insulator in a first direction or a second direction, and
a second receptacle shield configured to be arranged on a corner of the receptacle insulator while connecting the first receptacle shields without a break; and
a plurality of receptacle contacts arranged in one row with a pitch of an arrangement gap d1′ in the first direction on the receptacle bottom receptacle mount sections thereof mounted on the substrate each having a mounter gap d2′ and being exposed from the bottom surface of the receptacle bottom while being arranged in a zigzag manner on both sides in the second direction,
wherein the first receptacle shield and the second receptacle shield each include the first shielding portion configured to wrap around an outer circumference of the plug insulator without a break while having a height in the third direction, and
wherein the second receptacle shield includes a receptacle corner coupling portion configured such that a third direction upper end of the receptacle shielding portion is continuous without a break while covering the corner of the receptacle retaining wall.

13. The receptacle connector of claim 12, wherein each of the receptacle contacts has a bar shape having a length in the second direction, and includes:
a bottom contact section configured to be exposed on an upper surface of the receptacle bottom,
a fixing contact section configured such that one end of the bottom contact section is bent and extended upward in the third direction and is exposed on one side wall of the receptacle retaining wall,
a retaining wall fixing section configured such that an end of the fixing contact section extends to cover an upper surface of the receptacle retaining wall and is exposed,
a molding fixing section configured such that an end of the retaining wall fixing section is bent downward in the third direction and extended to be insert-molded into the receptacle retaining wall, and
a receptacle mount section configured such that the molding fixing section extends in the second direction and is exposed from a lower surface of the receptacle retaining wall and a portion thereof is configured to protrude outwardly in the second direction of the receptacle retaining wall.

14. The receptacle connector of claim 13, wherein each of the receptacle contacts includes:
an elastic arm section configured such that the other end of the bottom contact section extends and is bent upward in the third direction and extends, and
an elastic contact section configured such that an end of the elastic arm section extends in the third direction and is bent to be rounded, and an end thereof faces the receptacle retaining wall.

15. The receptacle connector of claim 13, wherein the bottom contact section includes:
a first width bottom contact section configured to have a first width a1′ and
a second width bottom contact section configured to have a second width a2′ narrower than the first width a1′ and extend from the first width bottom contact section.

16. The receptacle connector of claim 13, wherein the fixing contact section 232 has a fixing contact protrusion protruding from one side thereof.

17. The receptacle connector according to claim 14, wherein the receptacle retaining wall defines a contact displacement space B12 through which the elastic contact section is elastically deformable.

18. The receptacle connector of claim 14, wherein the receptacle shielding portion of the second receptacle shield includes an embossed contact portion protruding outwardly in the first direction or the second direction, or protruding outwardly along a corner thereof.
